(19) United States
(12) Patent Application Publication
(10) Pub. No.: US 2004/0142307 A1
(43) Pub. Date: Jul. 22, 2004

(54) Yearly psychic, tarot & love reading predictions for every astrological birth sign

(76) Inventor: Stephanie Adams, Brooklyn, NY (US)

Correspondence Address: Stephanie Adams, P. O. Box 140428, Brooklyn, NY, 11214, US

(21) Appl. No.: 10/348,138

(22) Filed: Jan. 21, 2003

(51) Int. Cl. G09B 19/00

(52) U.S. Cl. 434/106

(57) ABSTRACT

Yearly psychic, tarot & love reading predictions for every astrological birth sign, is an entirely new concept of a very popular, ancient tradition. Yearly psychic, tarot & love reading predictions for every astrological birth sign will not only be looked upon as highly useful for many believers, it will also be looked upon as an enlightening experience for everyone.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The belief in astrology, new age, spirituality and metaphysics is extremely popular, but no one has ever created yearly psychic, tarot & love reading predictions for every astrological birth sign before. Yearly psychic, tarot & love reading predictions will be published via book, magazine, newspaper, online, etc. by using a specific method.

### BRIEF SUMMARY OF THE INVENTION

The method for yearly psychic, tarot & love reading predictions involves choosing a form of divination to do a reading on every astrology sign for every month of the year for every category chosen. The results of each separate reading are recorded, documented and published in a concise format for everyone to read and refer to over and over again during the course of that particular year. These readings are expected to be done on a yearly basis and will usually be done in the same format.

### BRIEF DESCRIPTION OF THE SEVERAL VIEWS OF THE DRAWING

(Not Applicable)

### DETAILED DESCRIPTION OF THE INVENTION

The belief in astrology, new age, spirituality and metaphysics is extremely popular, but no one has ever created yearly psychic, tarot & love reading predictions for every astrological birth sign before. Yearly psychic, tarot & love reading predictions will be published via book, magazine, newspaper, online, etc. by using a specific method.

Method

A form of divination would have to be chosen. Divination involves using one or several of various practices, such as: tarot cards, oracles, crystal or fire gazing, scrying, pendulums, numerology, etc.

NOTE: Having a choice amongst various forms of divination, would apply to psychic and love readings. If a tarot reading is being done, then only tarot cards can be used. However, there are various tarot card decks and any of them can be used.

An astrological book, guide, calendar or any other form of reference material would be necessary to acknowledge and take note of all 12 astrology signs. The 12 astrology signs are: Aries, Taurus, Gemini, Cancer, Leo, Virgo, Libra, Scorpio, Sagittarius, Capricorn, Aquarius and Pisces

Each of the 12 astrology signs would be documented along with the time range for each separate astrological sign. The time range for each of the 12 astrology signs is as follows:

Aries (March 21-April 20)

Taurus (April 21-May 21)

Gemini (May 22-June 21)

Cancer (June 22-July 23)

Leo (July 24-August 22)

Virgo (August 23-September 23)

Libra (September 24-October 23)

Scorpio (October 24-November 22)

Sagittarius (November 23-December 21)

Capricorn (December 22-January 20)

Aquarius (January 21-February 19)

Pisces (February 20-March 20)

Each of the 12 months of the year (January, February, March, April, May, June, July, August, September, October, November and December) would be documented in each listing of astrology signs.

Various categories would be documented in each listing of months for every astrology sign. Each category would usually be a general topic of interest to most people in regards to their overall lives. An example of categories would be as follows:

Love

Health

Family

Friends

Business

Spiritual Growth

Personal Happiness

NOTE: The sample categories previously listed would apply to a psychic or tarot reading. A love reading would be categorized differently, since the topic is love. An example of categories for a love reading would be as follows:

For Those Who Are Attached

For Those Who Are Unattached

The form of divination chosen would be used to do a reading on every astrology sign for every month of the year for every category chosen. (A reading is the result when people use their psychic abilities to decipher a message that comes to them from any form of divination.)

The results of each separate reading are recorded, documented and published in a concise format for everyone to read and refer to over and over again during the course of that particular year.

These readings are expected to be done on a yearly basis and will usually be done in the same format.

Sample Of Method For: Yearly Psychic, Tarot & Love Reading Predictions For Every 2 Astrological Birth Sign (By Stephanie Adams)

### Leo

January

Love

Start the year off with a bang! Try to bring goodness into your life right from the beginning. Last year was a bit more different than the norm, but this year will prove to be filled with more wishes, opportunities and dreams come true than ever before.

Health

You are doing so well in regards to love, do not ruin your chance for greater health and wellness. Something will come into the picture that will have to be erased. You will have a small battle to fight, but you will ultimately be the victor.

Family

Do not allow others to fall back into a rut again. You do not have an interest in spending that much time with this person, but you do not want to see anyone you care about suffer. Help pick them up from a hole they dug and hope that they did not dig it for you.

Friends

You have a lot of expectations for a new (or renewed) relationship. Be careful not to have too many ideals set or you will be greatly disappointed in this person. In spite of your quest to find perfection, remember . . . no one is perfect . . . not even you.

Business

You might have a problem that you will have to go back to face. You thought you could move on without having to deal with it, but it is keeping you from moving forward smoothly. An opportunity is steadily coming your way, but it will seem questionable in the beginning.

Spiritual Growth

You will feel a sense of despair and hopelessness spiritually. Why feel this way when nothing around you is giving you this sort of vibration? You just fear the worst. Stop it! Do what you can to imagine a better tomorrow and a better tomorrow will surely come.

Personal Happiness

If not enough people are focusing on you, you feel that something is wrong with you. Sometimes it is good to not have the spotlight on you in order to relax a bit. Focus on improving your self for yourself and others will eventually take notice again.

Sample Of Method For: Yearly Psychic, Tarot & Love Reading Predictions For Every 3 Astrological Birth Sign (By Stephanie Adams)

### Leo (Continued)

February

Love

Can't face the heat? Stop trying to set others on fire. You're a tough cat, but sometimes too tough. Take a look at what you're doing and ask yourself if what you're getting back is what you are giving.

Health

Are you heading for trouble? You might be if you are moving along without direction or the desire to reach a specific destination. Take a note of your prospective path before you make another move. The next time you go out to prowl, you'll know better.

Family

What looks to be a small spat can escalate into a huge confrontation. If you can stay out of it and not worry too much, you will be better off. Otherwise, be prepared (or at least sedated) before you get into the middle (and to the bottom) of things.

Friends

You possess a great amount of strength and others either assist you in maintaining it or refer to you in order to develop some of it on their own. Be a source of strength for those you care about most and they will always be there for you even if you do not need them to be.

Business

Someone wants something from you badly and you are prepared for the worst scenario should you feel this person is a threat. It will not be wise to fight. You might be better off avoiding this certain someone because this person does not want anything other than to use you.

Spiritual Growth

It is amazing how you grab you inner goods and use them. You might not have it all, but you work your hardest with what you have. Keep up the good work and you will be further ahead than most. Maintenance is the key and you have to keep the door open.

Personal Happiness

Those who wish nothing but ill will upon you are so far away from you. You are not only on a higher level, you are untouchable. That should make you feel more at peace. You have put so much (and so many) behind you. There is a place for them behind you as well.

Sample Of Method For: Yearly Psychic, Tarot & Love Reading Predictions For Every 4 Astrological Birth Sign (By Stephanie Adams)

### Leo (Continued)

March

Love

So many want to be around you. Some might not know how to approach you. Others might not approach you to your liking and will get tossed aside. Few will approach you directly and in a non-threatening manner. You might not react as expected, but you will react.

Health

Let go of your pride somewhat in order to get where you have to be. Too much baggage will not enable you to move at the pace you are supposed to be going. Place your ideas and plans in a different order and you will move along with greater ease and performance.

Family

You did a number on someone. You did not mean any harm, but you got this person exactly where you wanted this person to be. Be humble and stop playing games or punishing an innocent person. You have to calm down before you meet again.

Friends

You are so good for another person's ego. You have a way of uplifting the spirits of many good companions. Now only if you could do the same for yourself, you would be in good shape. Be a morale booster to all those around you and others will totally appreciate it.

Business

After the darkness, comes the light. Work into the early hours of the morning and you will rise with a solution. Try to make sure that you receive the proper credit for your efforts or others will take (maybe even steal) your idea and run with it.

Spiritual Growth

Others told you not to do something. You put up such a fuss, because the advice given was not what you wanted to hear. Too bad, because if you took the advice, you would have been better off. Now that you have learned your first lesson this year, move on.

Personal Happiness

Someone is using your goodness and taking you for granted. This is something you will not tolerate. Should you attack? Most definitely not! You are a better person than this one is. Deal with this person in a cordial way and you will end up getting your point across better.

Sample Of Method For: Yearly Psychic, Tarot & Love Reading Predictions For Every 5 Astrological Birth Sign (By Stephanie Adams)

### Leo (Continued)

April

Love

Nothing good will come to you unless you are good enough to get it. This might seem like a blunt and harsh comment, but your pompous attitude must be knocked down. You are in a really good position to begin with. Modesty is more becoming.

Health

Congratulations! You will manage to defeat a bad habit or routine. You had to go with your instincts on a few matters and even though you were told differently by other people, your inner voices were telling you the right thing to do. Lucky you!

Family

Someone you gave helpful and inspirational advice to will take it and take off with many successes. You will definitely be proud but all you want is for this person to give you a little recognition. Ask for it! If you do not, you will build hidden resentment.

Friends

Do not allow someone dear to you to think that you can be controlled. You do not want another confrontation with this person, but maybe if you had nipped the problem the first time, this never would have happened again. Talk about it. You'll forgive, but you'll never forget.

Business

Do not get caught up in other people's drama. You might feel somewhat responsible, but you should definitely not feel that way, nor should you be held accountable in any way. Stay out of it! Unnecessary trouble will not make you look good.

Spiritual Growth

There is a greater reason beyond what you feel to be the reason why something is happening to you. All is not as bad as it seems. Hold your head up high as you normally do and you will eventually see part of that bigger explanation.

Personal Happiness

You should not look so much at your transgressions as much as you should look at your accomplishments. You have come a long way in such a short period of time. You have better control of your destiny than most. Count your blessings.

Sample Of Method For: Yearly Psychic, Tarot & Love Reading Predictions For Every 6 Astrological Birth Sign (By Stephanie Adams)

### Leo (Continued)

May

Love

This will be a powerful turning point in your life. It is hard to deal with matters that you will have to deal with at this present time, but you will somehow manage to generate even greater strength in order to live through it. From this point on, everything else is a piece of cake.

Health

What made you turn into a monster? Take the needed potion and come back to the human race. If you are not careful, you may start a bad cycle. But you won't, because you know what you have done wrong and you will make a personal vow to never do it again. Good for you!

Family

Do not let others tell you what to do, especially when it comes to you personal life. You have always expected the privacy of others, mainly because you have always wanted your privacy respected. Now tell your loved ones to leave you alone or you will leave them alone.

Friends

What you felt was the end of a beautiful friendship was actually a confrontation that made the two of you stronger. It might not appear to be this way at first, but you will see the improvement and witness the miraculous recovery before you know it.

Business

Something that seems too good to be true just might be. You will profit greatly from a certain deal, but it will not be as incredible as promised. If you come to the table prepared, you will stop others from cooking up an exaggerated scheme.

Spiritual Growth

You have a special place where you need to be. Do you know where you are going? Even if you do, you might be heading in the wrong direction. Stop for a minute to make sure that you are going the right way and you will even end up leading the way for others.

Personal Happiness

Many look to you with a tremendous amount of respect. If you did not deserve it, so many would not feel the same way about you. Sit back out of the limelight and reflect upon your year thus far. Something will try to take your happiness away, but it will not succeed.

Sample Of Method For: Yearly Psychic, Tarot & Love Reading Predictions For Every 7 Astrological Birth Sign (By Stephanie Adams)

### Leo (Continued)

June

Love

Try not to beat up on those who only mean to help you. It takes a strong person to be able to handle you and know that you growl more than you bite, but there is but so much one can take before one gets tired of unnecessary drama. Try to be softer.

Health

Someone you care about deeply is there for you when you need it most. It is unusual for you to show your weakness and vulnerability to someone, unless you feel that the certain someone you show your sensitive side to will not attack you.

Family

Temper, temper! You might look for a fight if others do not look at what they are doing wrong. Whether you can get control over the situation or not, try to get control over yourself. Tension may flair, but if you remain calm and ask for peace, you will receive it.

Friends

Do not mix friendships with any other form of relationships. By doing so, you will lose whatever you had as well as whatever you tried to have. Others might not be aware of it, but you are not stupid. Are they? They must be if they think you are!

Business

Someone will come into your professional life and offer you an opportunity that is totally unbelievable. Before you get your hopes up too high, you must take a good look at this person. By doing so, you will be able to determine whether or not the offer is real.

Spiritual Growth

Do you feel overwhelmed? If so, you might want to take a step back and make a list of what you have done as well as what you need to do. Keep the faith in yourself and you will accomplish a lot more than expected.

Personal Happiness

The two of you were brought together for a very important reason. You know what that reason is, but you have yet to really meditate on it and accept it. Nothing that has come before you has gone by unnoticed. Let this person know that you see and understand this person completely.

Sample Of Method For: Yearly Psychic, Tarot & Love Reading Predictions For Every 8 Astrological Birth Sign (By Stephanie Adams)

### Leo (Continued)

July

Love

If you are not careful, you will scare someone away with your hot temper. This person is not a danger to your existence. Why do you react the way you do sometimes? Ask yourself that often enough and you will stop treating people as if they are candlewicks.

Health

You see someone you love as needing your strength again. This will not be a problem. The only problem you will have is not breaking down when you are not around this person. You hate to see a loved one suffering, but there is not much more you can do.

Family

You are better than the fight you are about to get into. What is wrong? You want peace, but lately, it seems as if you can only have it when you are alone. Spend some time away from an issue and away from a person causing it. It will work out in the end.

Friends

You might not know where your friend is going with something, but you do know that it is headed in your direction. Is this just another chance to give advice? It might be. It also might be that your friend needs a favor that you cannot (or are not really willing to) oblige.

Business

Do not sink your teeth into a trap. You are definitely hungry for approval, acceptance and attention, but this will not be the easy (or right) way for you. Avoid a confrontation by avoiding a meeting or function. You will find out later, why it was the right thing to do.

Spiritual Growth

Are you listening? Your spirits are whispering to you. Thank goodness they are not yelling, because that means that you did not do anything wrong this time. If you cannot listen to others who are certainly experienced, at least follow the guidance of your spiritual guides.

Personal Happiness

If you want something, you will have to take it now. Being aggressive is not like you, but when you are, it comes natural. Need a lift? The wheels are turning and you better hope that you are already down. Otherwise you will be.

Sample Of Method For: Yearly Psychic, Tarot & Love Reading Predictions For Every 9 Astrological Birth Sign (By Stephanie Adams)

### Leo (Continued)

August

Love

You will make sure someone you care about, will not have the same experience again. What has transpired might have been the beginning of the end. Nevertheless you will take charge and take it to the level that it needs to be on . . . the bottom.

Health

Do not show your vulnerable side, even though you are feeling vulnerable. Are you unsure about something? Ask, but in a way that you will not come across as a complete idiot. Make a wish, because miracles do happen. Make sure you do not tell anyone until it comes true.

Family

Someone you love a great deal will reach out to you suddenly. Listen. The communication between the two of you will be stronger and more direct than ever. This will be good, because what is being said to you will benefit you beyond the expected.

Friends

Your mentor or most trusted confidante has a desire to reach out to you now? Are you dying? That is highly unlikely. It is just that a few loved ones see a side to you (or a side of your life) that has to be turned over and dealt with. Do not fret . . . just be a good listener.

Business

Great fortune is coming your way! You might have to make a few extra moves or take a few extra actions to get to it, but do what it takes and have your piggy bank handy. Count your coins, but do not forget to count your blessings

Spiritual Growth

Drama! You love it. You normally need it. But now that you should not have it, you welcome it unknowingly. In order to get your life back to the wonderful way it should be, you have to sacrifice and take a few punches. You're a fighter and you will always be a winner.

Personal Happiness

Something that has been a struggle for you is going to break. This break will be a clean one and you will find yourself free from any further repercussions from it. Not many people can say that their problem got solved on their own, so consider your self fortunate.

Sample Of Method For: Yearly Psychic, Tarot & Love Reading Predictions For Every 10 Astrological Birth Sign (By Stephanie Adams)

### Leo (Continued)

September

Love

Something wonderful is coming your way, but you cannot see it clearly enough to determine that on your own. Relax. You do not always have to be on guard when it comes to love. You just have to decipher the times you should be on guard from the times you shouldn't be.

Health

Bad, bad, bad! What do you want to do? Kill yourself? Get your self back to being better to yourself and you will not get scolded again by those who love you or are genuinely concerned. Do you have a routine? If not, then you should start one.

Family

Low and behold, someone great will come along. This person will bring good cheer and merriment. This person has either not been around in a while, or is completely new to everyone. Nevertheless, this will be a good break from the monotony.

Friends

Where did your friend go? Did you do or say something wrong? Do not worry. Sometimes people need a break from being around others (even their loved ones) because they have their own issues to work out and would not want to share those burdens with anyone else.

Business

Is there a catch to this? You wonder that too often. This opportunity will not only catapult you to another level, but it will even bring with you, those who need to be there for you. You strive to excel, but you also try to help others along the way.

Spiritual Growth

This is time to grow even more. Just when you think that you are in a good, you get even better. Be proud of yourself. So many others are. Even though you have a few kinks that you'd like to iron out, you must give yourself a break and not be so hard on yourself.

Personal Happiness

Happiness is yours and this time, you must sit and wait for it. This is not easy for you to do, because you are so used to being aggressive and straightforward. Learn the art of patience and blend it with a little touch of humility. The combination is invigorating.

Sample Of Method For: Yearly Psychic, Tarot & Love Reading Predictions For Every 11 Astrological Birth Sign (By Stephanie Adams)

### Leo (continued)

October

Love

Someone wants to reach out to you and this person will not be afraid to do so. You are flabbergasted! Why? Are you not worthy of such a flight of fancy? This is a change. Maybe if you weren't always so aggressive, something like this would happen more often.

Health

You are not doing the right thing for yourself. You will have to either learn one last time, or learn the hard way the next time. No one is going to make you do anything you do not want to do. Just be smart about your final decisions.

Family

What did you do to make such a sudden change in your closest relationships? It might seem as if it was a quiet disaster, but it will prove to be an action leading towards more understanding and fulfillment. A meeting will be good for anyone you feel should attend.

Friends

Turn your back on a certain friend and you will turn around and see this person gone. There might be a few who will put up with your temper tantrums and bossiness, but even to those few, it gets old. Rebuild a solid structure if it has not been too damaged and be nicer!

Business

A collective effort on many parts will be called for to make you feel better about a recent error. Even though you did your best, you did not do what had to be done. Stop pondering over this same issue. Something grand will come out of it and you will see soon enough.

Spiritual Growth

You sink deeper and deeper into a grave. Get up! Your time will come, but this is not it. It's not even your time to be recycled, so do not allow a few imperfections on your part to make you want to take any drastic steps.

Personal Happiness

Even though you struggle with the good and evil in the world, you overall feel the goodness in others. Take a break (or a quick vacation) if you can. You need it! It's been a long time (or it feels like it has been a long time) since you had one.

Sample Of Method For: Yearly Psychic, Tarot & Love Reading Predictions For Every 12 Astrological Birth Sign (By Stephanie Adams)

### Leo (Continued)

November

Love

You will break someone down to the bare necessities (in a psychological sense). This is something you are good at and enjoy doing. Now that you are doing it to someone you care about, you must let the person know why you are doing it or the will feel naked.

Health

You might not be the best at helping yourself in this department, but you are at least very skilled at helping or convincing others to do the right thing by themselves. Practice what you preach and you will not have to suffer so unnecessarily.

Family

Congratulations on masterminding the perfect reunion! This might seem as if it was a sneaky, deceitful scheme, but you intentions were indeed honorable. Any and every party involved will be sure to let you know how crafty, yet caring you were to do what you did.

Friends

Friends stick together at all costs. Is your friend a true one? You will find out this month. Your friendship with this person will be tested. This test will come about by forces beyond your control. Nevertheless, you needed to know the answers, because you did have questions.

Business

All that you were taught to do will come in handy in a particular professional predicament. You are not as worried and you are not as concerned as others are right now. Maybe your calmness is the real cause of you not being looked upon as the blame. Nice going!

Spiritual Growth

You have a higher purpose and that purpose will be revealed in the near future. For now, reflect upon your present purpose as well as your purpose in your past. Analyzing all points in time will make you realize how much further you have to go to reach you final objective.

Personal Happiness

Something (or someone) is coming to you. Maybe you would prefer to be to yourself, but that is not the way it is going to be right now. You value your private time. Set up some time to be alone for a bit, because you are in for a lot of socializing.

Sample Of Method For: Yearly Psychic, Tarot & Love Reading Predictions For Every 13 Astrological Birth Sign (By Stephanie Adams)

### Leo (Continued)

December

Love

You might be difficult to be with sometimes, but those who love you and are loved by you will put with just about anything you throw their way to catch even a portion of the love you have to give them. You love to give love and even though you had a lot to deal with, others felt it.

Health

Go with your notions! You are doing quite well and should be happy. You have now managed to keep a good balance between listening to others and listening to your body. Your actions can be seen as a bit odd at times, but if they work for you, then keep taking them.

Family

You will avoid certain people and evade certain issues now. Maybe your new approach should be your permanent one because not only do you keep the peace with others, you give yourself peace of mind. No can argue with a person who does not argue back.

Friends

Even though they are not as fortunate as you are, your real friends will be genuinely happy for whatever wonderful comes your way this month. Did you give a party as of yet? If you didn't, you should, even if it is in a restaurant. You are excellent at bringing people together.

Business

You will get out of this year pretty much what you put into it. You will also accomplish this year pretty much what you set out to accomplish. Stop trying to look at what you missed or where you failed, because you have to relax once in a while and relish in the achievements.

Spiritual Growth

Your spirit is a bit saddened at a few let downs this year. Overall you have done so much and have so much to be happy about. You have a great deal to look forward to in the near future. Keep your head up and do not lose track of your inner guide. It is always there to help you.

Personal Happiness

Just when you feel as if you are going to crack, all of the pieces will fall perfectly into place. What a way to end a roller coaster ride of a year! Someone was watching over you and if you weren't a good soul, you wouldn't have been given so many good memories.

1. I claim the creation of and method of creating yearly psychic, tarot & love reading predictions for every astrological birth sign.
